(19) United States
(12) Patent Application Publication
(10) Pub. No.: US 2018/0245734 A1
(43) Pub. Date: Aug. 30, 2018

(54) Attachment and Securement System

(71) Applicants: Steve W. Kim, Artesia, CA (US); Joseph Kim, Artesia, CA (US); Eun-Jin Kim, Artesia, CA (US); Ki-Hyung Han, Los Angeles, CA (US)

(72) Inventors: Steve W. Kim, Artesia, CA (US); Joseph Kim, Artesia, CA (US); Eun-Jin Kim, Artesia, CA (US); Ki-Hyung Han, Los Angeles, CA (US)

(21) Appl. No.: 15/443,410

(22) Filed: Feb. 27, 2017

(51) Int. Cl. F16M 13/02; F16M 11/14; F16M 11/40; F16M 11/04; F16B 1/00; B60R 11/02; B60R 7/10; H04M 1/04

(52) U.S. Cl. CPC F16M 13/022; F16M 11/14; F16M 11/40; F16M 11/041; B60R 2011/0005; B60R 11/0252; B60R 7/10; H04M 1/04; F16B 2001/0035; F16B 1/00

(57) ABSTRACT

An attachment and securement system that allows an item to be secured onto a surface or a structure, and to be selectively positioned. The system consists of a first assembly with a magnet and an interface, and a second assembly with a screw actuated clamp and a post that terminates at a circular metal head. The first assembly is attached to an item such as a mobile communication device, a computing device, apparel, or an apparel accessory. The item with the attached first assembly is then placed in contact with and magnetically adhered to the second assembly, which is attached to a surface or structure. The magnet secures the item to the second assembly, and the circular design of the metal head allows the head to rotate about the magnet, allowing the item to be selectively positioned.

### TECHNICAL FIELD

The invention generally pertains to attachment/securement devices, and more particularly to an attaching and securing system that allows an item to be secured to a surface or a structure, and to be selectively positioned.

### BACKGROUND ART

In today's world people rely on a large number of items/objects to facilitate daily requirements. One of the most used items is a mobile communication device, which is also known as a smart phone or cell phone, as well as the related tablet computer. The degree to which people have become reliant on these devices makes it necessary for many people to have their device in close proximity at all times. Frequently, this not a problem, but there are occasions such as when driving that accessing and using a device can be difficult, and in some locations illegal. There is also a problem in that due to the compact size of many devices it is easy to misplace a device or effort is required to find a suitable location where a device is readily accessible but also unobtrusive and safe.

There have been various attempts to produce products including apparatus, assemblies, etc. that are capable of maintaining a device, as well as other objects/items, in a convenient, easily accessible location that is also unobtrusive and provides protection of the device. Many of these products are specifically directed at use within vehicles, since vehicles present a unique situation. A driver must primarily be concerned with the operation of the vehicle, including near-constant attention on the environment in which he/she is driving. Modern communication devices, while easy to use, do require certain a amount of concentration/attention to carry out many of the functions. This is the reason talking and texting (essentially using) a device while driving is illegal in many locations.

Although it is dangerous to talk on a device while driving, much of the danger occurs when interacting with the device's functions such as when texting, dialing a number, and using apps or the internet. Usually, to facilitate these actions a device is held in a person's hand, while with the other hand commands on the device are performed. Another problem is in simply accessing a device while in a vehicle, as well as other times. Typically, placing a device in a readily accessible location can be difficult, so a person must divert attention to finding and grabbing/holding the device. Additionally, it is common for a device is placed in an un-stable location (such as on a dashboard) where even a minor movement can cause a device to fall, often into a difficult or impossible to access spot. In some instances, such as after an accident when a person desperately requires his/her device, they cannot find or access the device.

What is needed is a secure means of securely maintaining an item such as a communication device at a location (either within a vehicle or at any other required location) that facilitates easy access to and use of the item/device. Optimally, an item/device could be easily placed on, maintained on, and removed from, the location, as well as allowing a device to be selectively positioned depending on a person's requirements and/or desire.

A search of the prior art did not disclose any literature or patents that read directly on the claims of the instant invention. However, the following U.S. patents are considered related:

| PATENT NO. | INVENTOR | ISSUED |
|---|---|---|
| 5,992,807 | Tarulli | Nov. 30, 1999 |
| 6,149,116 | Won | Nov. 21, 2000 |
| 6,888,940 | Deppen | May 3, 2005 |

The U.S. Pat. No. 5,992,807 patent discloses a cell phone that is removably attached to the dashboard of a vehicle by means of a magnet which is permanently secured to the dashboard. The cell phone is removably retained by the magnet and the cell phone may be lifted off manually and manually replaced. The magnet has a front face provided with a rubber layer that provides frictional resistance to prevent the cell phone from slipping down.

The U.S. Pat. No. 6,149,116 patent discloses a holder for a mobile telephone. The holder includes a main body to which a mobile telephone is magnetically attached, and an angle controllable attachment supporting means for attaching the main body to the surface of an object such as a vehicle dashboard. The magnetic attachment means includes a magnet fixed to the main body, and a piece of iron attachable to the back of the mobile telephone. The angle controllable supporting means comprises a pair of hinge-connected supports which are also hinge-connected to the bottom of the main body.

The U.S. Pat. No. 6,888,940 patent discloses a magnetic holder for cell phones. The holder includes a cup formed of a ferromagnetic material or the like within which a magnet is supported. The rear surface of the cup includes a double-sided adhesive paid for attaching the cup to a vehicle dashboard surface or the like. A friction ring encircles the front edges of the cup to provide enhanced retention of a cell phone secured to the cup by magnetic attraction between the internal magnet and the cell phone battery.

For background purposes and indicative of the art to which the invention relates, reference may be made to the following remaining patents found in the patent search.

| PATENT NO. | INVENTOR | ISSUED |
|---|---|---|
| 3,416,761 | Shanok, et al | Dec. 17, 1968 |
| 4,560,831 | Bast, et al | Dec. 24, 1985 |
| 5,060,260 | O/Connell | Jul. 24, 1990 |
| 2016/0173667 | Gutierrez | Dec. 11, 2014 |

### DISCLOSURE OF THE INVENTION

In its basic design, the attachment and securement system is comprised of a first assembly and a second assembly. The first assembly consists of a magnet and a metal interface having an opening. The second assembly consists of a clamp having an outward extending post that terminates at a circular metal head. The magnet is placed on a lower surface of the interface such that the magnet is exposed through the opening on the interface. The first assembly consisting of the magnet and the interface is attached to an item, such as a mobile communication device, i.e., smart phone or cell phone. The second assembly is attached onto a surface or structure, which can laterally be almost any horizontal or vertical surface. The item with the attached first assembly is placed onto the second assembly such that the magnet exposed through the opening is aligned with and contacts the metal circular head, thereby magnetically adhering the item with the first assembly to the second assembly. The circular design of the metal head allows the head to rotate about the magnet, allowing the item to be selectively positioned.

An alternate design comprises a first assembly consisting of a magnet having an opening that is attached to an interface with an opening. The two openings are equally dimensioned and aligned. The second assembly is the same as the first design. The circular metal head contacts and is magnetically adhered to the first assembly, and an item with the first assembly attached is able to rotate about the magnet and to be selectively positioned.

The system is particularly useful for securing a mobile communication device to an interior vehicle surface, such as a dashboard or center console. In this application a person can secure, position and use the device in hands-free mode while safely maintaining his or her eyes on the road, and be assured that the device will not fall, even in the event that the device or the surrounding environment is impacted. The system can also be effectively used on apparel or apparel accessories, such as a jacket, a sweater, pants, a belt, a backpack or an item that is worn on apparel such as a portable music or video player. It should be noted that the size of the system depends on the application for which it is utilized. For smaller or lighter items a small moderate strength magnet can be used, while larger, heavier items will require a magnet having a greater size with stronger magnetic capability.

In view of the above disclosure, the primary object of the invention is to provide an attachment and securement system that allows an object to be secured to a surface or structure and to be selectively positioned for optimal use.

In addition to the primary object, it is also an object of the invention to provide an attachment and securement system that:
is easy to use,
is long lasting and durable,
can be used to secure a variety of items,
improves safety when used in a vehicle,
does not interfere with the functionality of an item to which it is attached or used in combination with,
is easy to manufacture,
can be marketed and sold along with many items/devices,
can be made in a variety of sizes and colors, and
is cost effective from both a manufacturer's and consumer's point of view.

These and other objects and advantages of the present invention will become apparent from the subsequent detailed description of the preferred embodiment and the appended claims taken in conjunction with the accompanying drawings.

### BRIEF DESCRIPTION OF THE DRAWINGS

FIG. 1 is a side elevational view of an attachment and securement system with a first assembly attached to a rear surface of an item, and positioned above a second assembly prior to the first assembly being magnetically secluded to the second assembly.

FIG. 2 is a top plan view of the first assembly of the system's first embodiment.

FIG. 3 is a bottom plan view of the system's first embodiment.

FIG. 4 is a side elevational view of the first assembly of the system's first embodiment.

FIG. 5 is a side elevational view of a second assembly of the system's first embodiment.

FIG. 6 is a top plan view of the second assembly of the system's first and second embodiments.

FIG. 7 is an orthographic view of a female magnet element of the system's second embodiment.

FIG. 8 is a top plan view of the female magnet element of the system's second embodiment.

FIG. 9 is a side elevational view of a male interface element of the system's second embodiment.

FIG. 10 is a side elevational view of the female magnet and the male interface of the system's second embodiment.

FIG. 11 is a side elevational view of an extension arm that is used with the system.

FIG. 12 is an orthographic view showing an alternate design of the system's second assembly prior to being attached onto a backpack strap.

### BEST MODE FOR CARRYING OUT THE INVENTION

The best mode for carrying out the invention is presented in terms that disclose a preferred embodiment, with multiple design configurations, of an attachment and securement system. Often it is necessary maintain an item 120 such as a mobile communication device, i.e., smart phone or cell phone, or a tablet computer, at an easy to access location that also facilitates the use of the item 120 when required or desired. This also applies to items that are attached to apparel or apparel accessories. A major aspect of this ability is that it must be quick and easy to place an item on or remove an item from a location, and when placed, an item can be selectively positioned for optimum use or viewing. Also, when placed, an item must be secured in a manner that ensures the item will not become dislodged or fall from the location.

The instant inventive system fulfills all of these requirements and provides a means by which a person can quickly and easily secure an item at a location, and can selectively position the item for optimal use. It should be noted that while the system can be used to secure many types of items or objects to various locations, the system is particularly effective when used to secure personal items such as a mobile communication device or a tablet computer, or an item that is attached to apparel.

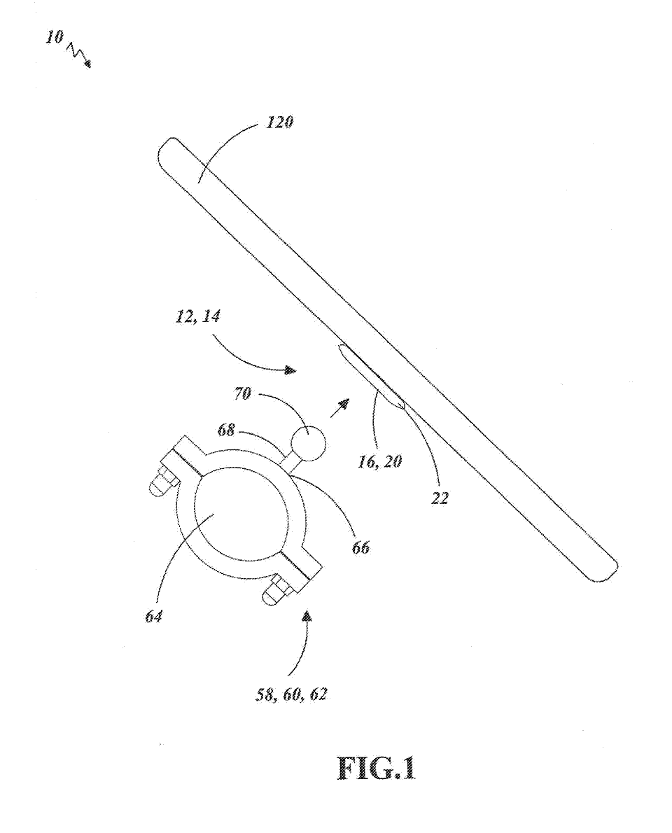

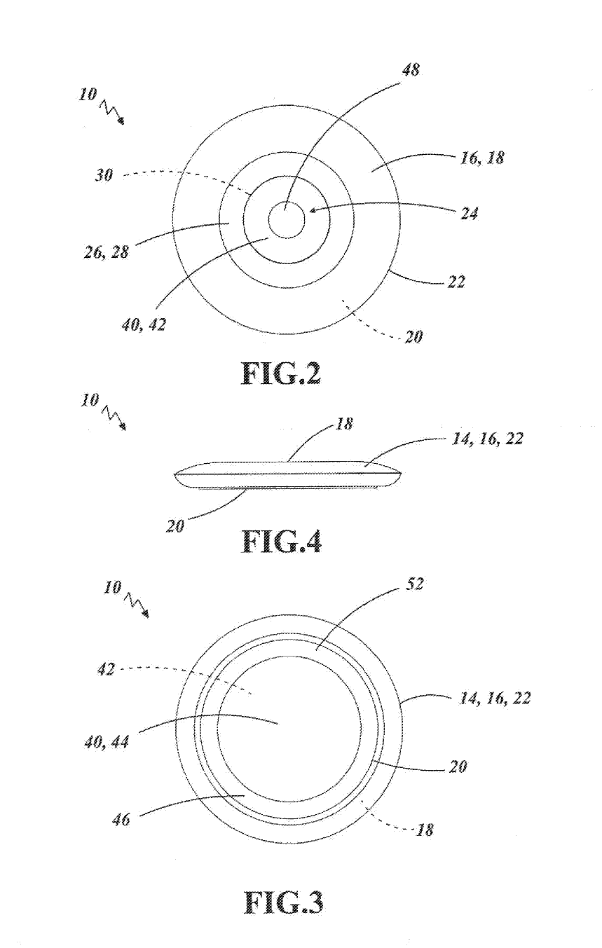

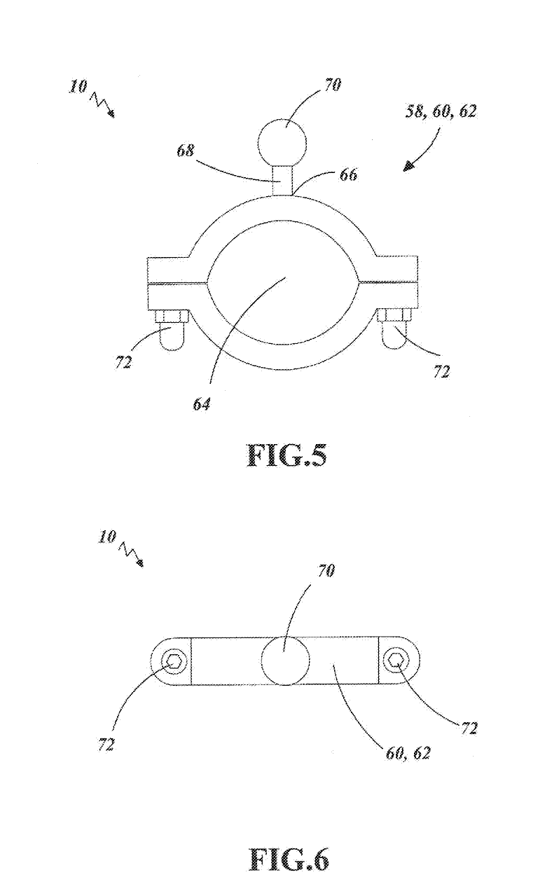

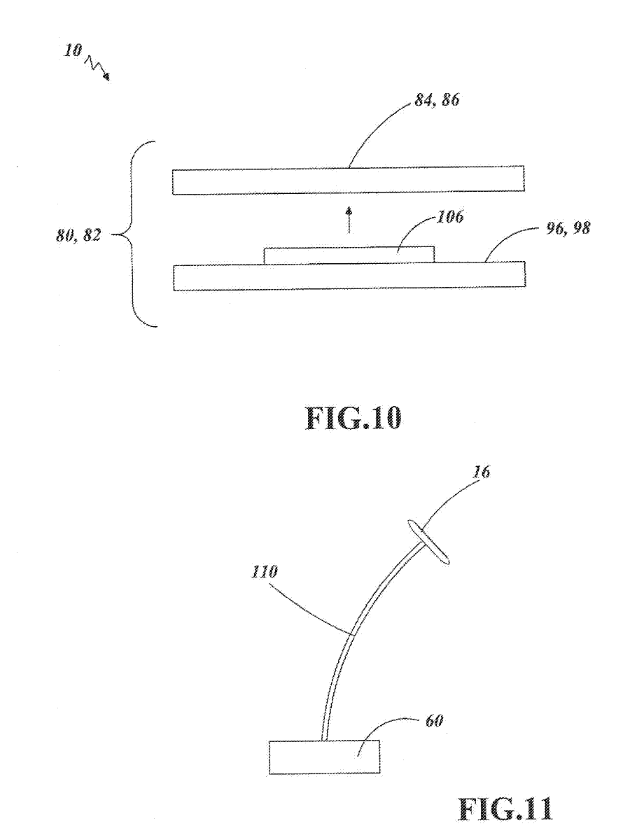

The attachment and securement system 10, which is known as the XOOX Clip™ and is shown in FIGS. 1-12, essentially consists of two major embodiments with alternate design configurations. The first embodiment 12, as shown in FIGS. 1-5, includes a first assembly 14 comprising a magnet 16, an interface 26, and a magnet mating insert 40. The magnet 16 has an upper surface 18, a lower surface 20 and a perimeter edge 22, a cavity 36, and an opening 24 extending through the magnet and located at the magnet's substantial center. If desired, as shown in FIG. 2, the opening 24 can have an at least two level stepped design, with an inward taper 38 at the bottom.

The magnet can be one of various types of magnet, including neodymium iron boron (NdFeB), samarium cobalt (SmCo), alnico, or ceramic/ferrite.

The interface 26 can be made of various materials including metal, plastic or a composite, and has an upper surface 28, a lower surface 30, a perimeter edge 32, and extending through the interface is an opening 34. The magnet mating insert 40 which is made of metal also has an upper surface 42, a lower surface 44, a perimeter edge 46, and an optional upward extending tab 48. It should be noted that in lieu of a tab 48 an opening can be utilized. The insert 40 is dimensioned to fit over the opening 24 on the magnet's lower surface 20, as shown in FIG. 3. The insert 40 is maintained on the magnet 16 either by press-fit or an attachment means such as an adhesive (not shown). The insert can also be integrally machined with the interface. When the interface 26 is within the magnet's cavity 36, the magnet's opening 24 and the interface opening 34 are aligned to create a single opening. Also, when the interface 26 is within the cavity 36, the interface's dimension creates an inner lip 50 that circumvents an inner surface of the magnet's perimeter edge 22. The magnet 16 and the magnet mating insert 40 are similarly dimensioned. It is important to note that the magnet 16, interface 26 and insert 40 are all preferably circular, although other shapes, especially oval geometric shapes could also be utilized.

As shown in FIG. 3, lower surface 20 of the magnet 16 contacts and is magnetically adhered to the upper surface 42 of the interface 26 that is within the cavity 36 on the lower surface 30 of the magnet 16. When the insert 40 is attached, the lower surface 20 of the magnet, along with the inner lip 50 of the interface 26 create a substantially flat, flush surface. Additionally, as shown in FIG. 3, a protective ring 52 can extend along the inner perimeter edge on the magnet 16. The ring 52 is preferably made of a resilient material such as soft plastic, rubber or nylon and provides a non-metallic contact surface when the first assembly is attached to an item 120, thus protecting against scratches or other similar damage.

The second assembly 58, as shown in FIGS. 1, 5 and 6, is comprised of a securing member that includes of a clamp 62 having an opening 64, a cavity 66, and a post 68 that extends outward from the cavity 66 and that terminates at a circular metal head 70. The opening 64 on the clamp 62 can be enlarged or reduced by use of at least one adjustment screw, thereby allowing the clamp 62 to be attached to surfaces or structures of various sizes. It should be noted that this particular clamp design is well known in the art. Other designs can also be used with equal efficacy. The type/design of the clamp (or other attachment device) that is utilized is determined by the requirements of the application or desire of the user.

The second assembly is clamped onto a surface or a structure, and the first assembly is attached onto an item 120. The item is then aligned with the second assembly such that the opening on the interface through which the magnet is exposed is directionally in-line with the circular metal head on the securing member, as shown in FIG. 1. The first assembly magnet 16 contacts the second assembly circular metal head 70, thereby securing the item 120 to the surface or structure to which the securing member is attached. The circular metal head can then rotate within the opening about the magnet 16, allowing the item to be selectively positioned.

The dimension of the circular head 70 relative to the size of the opening produce an unique effect that when the circular head is within close proximity to the opening the magnetic force emanating from the opening directionally pulls the head towards the opening, thereby creating a strong connection of the head to the magnet. One of the benefits of this is that a person can attach an item 120 with the first assembly to the second assembly without maintaining constant visual attention.

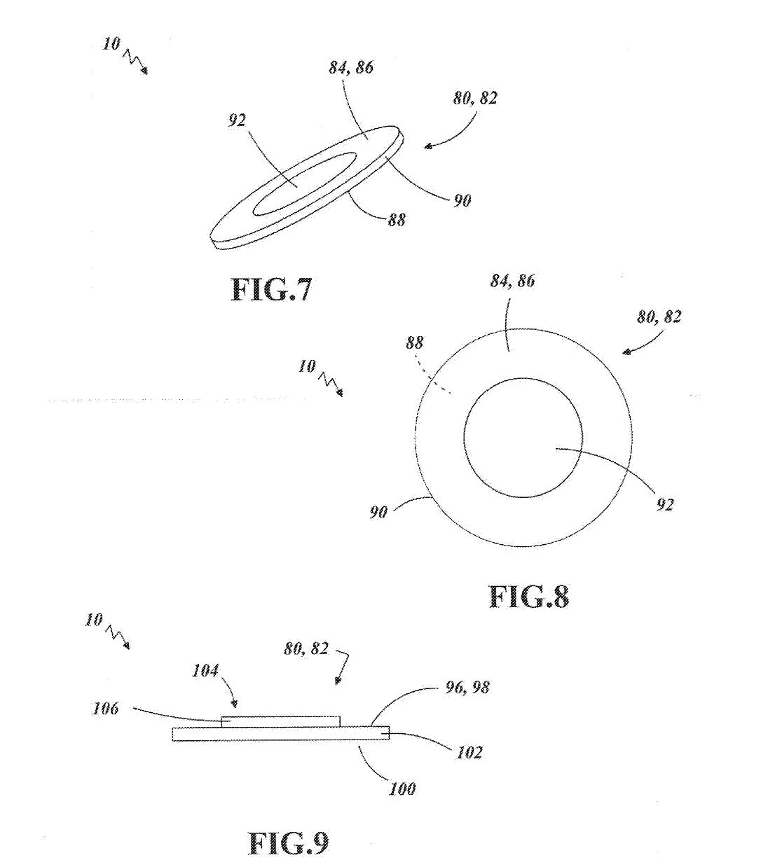

In a second, alternate embodiment 80, as shown in FIGS. 7-12, the system 10 is also comprised of a first assembly 82 and a second assembly 58. The first assembly 82 includes a magnet 84 having an upper surface 86, a lower surface 88, a perimeter edge 90, and an opening 92 located at the substantial center of the magnet. The structural appearance of the magnet 84 is similar to a conventional washer, as well known in the art. The first assembly 82 also includes a metal interface 96 having an upper surface 98, a lower surface 100, and a perimeter edge 102. An opening 104 is located at the substantial center of the interface, and circumventing the opening 104 is an upward extending flange 106, as shown in FIG. 9.

The magnet 84 and the interface 96 are preferably circular, and are equally dimensioned, thus allowing the magnet opening 92 and the interface opening 104 to mate. The upper surface 98 of the interface 96 contacts and is magnetically adhered to the lower surface 88 of the magnet 84. Once the magnet 84 and the interface 96 are together, the respective openings 92,104 align and the flange 106 around the interface opening 104 extends upward through the opening on the magnet 84. Essentially, the first assembly 82 of the second embodiment 80 utilizes the magnet as a female structure, and the interface as an associated male structure, with the male structure attached directly to an item 120.

Additionally, to increase the functionality of the first assembly 82, a slight vertical opening (not shown) can extend from the upper section of the magnet 84 to the opening, thereby allowing the second assembly 58 to also easily rotate or slide.

The second assembly of the second embodiment 80 is the same as the second assembly disclosed in the first embodiment, with a securing member 60 preferably a screw 72 actuated clamp with an opening, and a post that terminates at a metal circular head 70.

The second assembly 58 is attached to a surface or structure, and the first assembly is attached to an item 120, such as a mobile communication device, i.e., smart phone or cell phone, or other item including apparel and apparel accessories. The item 120 is aligned with the second assembly such that the openings on the interface and the magnet 84 are directionally in-line with the circular metal head 70 on the securing member 60, as shown in FIG. 1. When the first assembly 82 contacts the second assembly 58, metal head 70, the item 120 to which the first assembly is attached is secured on the surface or structure that has the securing member attached. As a result of the design, the circular metal head 70 adhered to the first assembly magnet 84 is able to rotate within the openings 92,104 about the magnet, thereby allowing the item 120 to be selectively positioned.

As previous disclosed, the second embodiment 80 utilizes a male interface and a female magnet. In an alternate design configuration, the second embodiment 80 can be utilized without a female structure. Since the system 10 functions by use of magnetic attachment and securement, the elements that comprise the system 10 are preferably made of metal. If desired or required, the elements can be made of either materials including plastic, a composite or wood, as long as the magnet can be accessed and contact the circular head on the second assembly.

To increase the functionality of the system 10, an extension arm 110, as shown in FIG. 11, can be utilized. The extension arm 110 can be any length or extendible, can be flexible or rigid, and can be made of a variety of materials. The extension arm 110 provides an additional structural element that allows an item 120 attached by the system 10 to be placed and maintained at a required or desired distance.

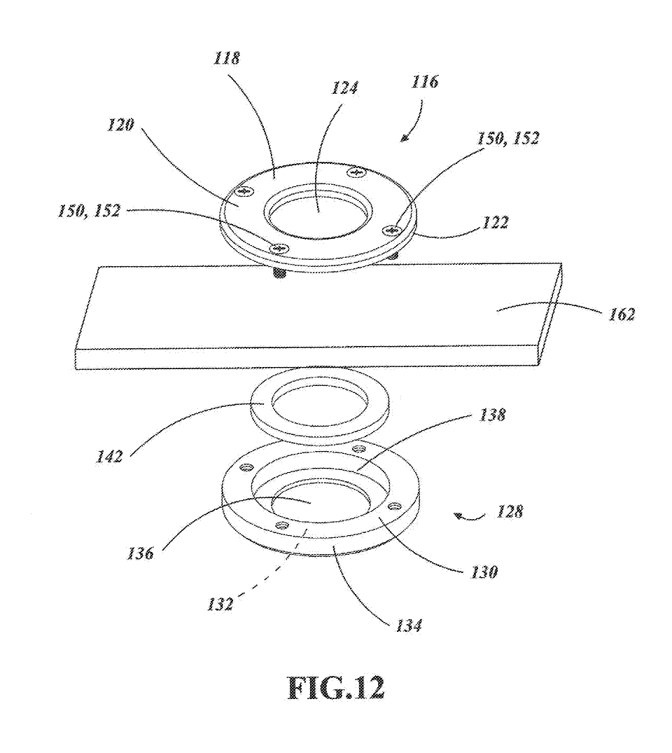

In one of the most effective applications and as the preferred embodiment, the system 10 is utilized to secure an item 160 onto an apparel accessory, particularly a backpack strap 162. For this use, an alternate design of the second assembly is preferable. As shown in FIG. 12, the alternate design of the second assembly 58 is comprised of a first section 116 which is considered a male member, having an upper surface 118, a lower surface 120, a perimeter edge 122, and an opening 124 located at the substantial center of the first section 116.

A second section 128, which is considered a female member has an upper surface 130, a lower surface 132, a perimeter edge 134, an opening 126 located at the substantial center of the second section 128 and in alignment with the opening 124 on the first section, and a cavity 138 extending downward into the upper surface 130. An insert ring 142 is dimensioned to be inserted into the cavity 138.

This design of the second assembly is attached by attachment means 150 onto a backpack strap 162, or other surface or structure, with the first section 116 located on an outer surface and the second section 128, including the insert ring 142, located on an inner surface. An opening is made in the backpack strap and the two sections 116,128 are attached in a manner that the openings 124,136 on the two sections correspond to the opening in the strap 162. Once attached, the two sections 116,128 create an interface for the first assembly which is attached on an item.

While a circular shape is preferred, the first section 116 and the second section 128 can be any geometric shape. Also, for all the embodiments and design configurations, the female member is always a magnet, while the male member can be magnet or just made of metal. Also, while three elements comprise this design, a one-element or two-element design can also be utilized.

The attachment means 150 for attaching the first section 116 to the second section 128 can be at least two screws 152, as shown in FIG. 12, an adhesive, at least two male and female detents, or a press fit. The attachment means 150 utilized depend on the type of material and the thickness of the material onto which the second assembly is attached.

For all the embodiments, other modifications to the design can also be utilized. For example, a magnet ring (not shown) can be placed onto or into a cavity on either the first assembly or second assembly. And, the circular head 70 can be omitted or replaced by an alternate structure.

In conclusion, while the system is particularly effective for use with a mobile telephone or tablet computer, the system 10 can effectively be used for a large number of, and variety of items. Depending on the requirements as dictated by the size and weight of an item, the system can be manufactured to high strength capability and tolerances. Also, the second assembly can be numerous types of attachment devices that can be effectively utilized including permanent and non-permanent means. The structure to which the system is attached can include, but not limited to, a vertical surface, a horizontal surface, an internal vehicle surface, an external vehicle surface, a furniture surface, or a non-stationary surface or movable surface, such as a picture frame. Additionally, the system can be used on apparel or apparel accessories such as a back pack, belt, suspenders or other similar accessories including a portable music or video player.

While the invention has been described in detail and pictorially shown in the accompanying drawings it is not to be limited to such details, since many changes and modification may be made to the invention without departing from the spirit and the scope thereof. Hence, it is described to cover any and all modifications and forms which may come within the language and scope of the claims.

1. An attachment and securement system that allows an item to be secured onto a surface or a structure and selectively positioned, wherein said system is comprised of a first assembly with a magnet having an opening and an interface having an opening, and a second assembly with attachment means having an outward extending post that terminates at a circular metal head, wherein said magnet is placed on a lower surface of said interface such time said magnet is exposed through the opening on said interface, wherein said first assembly comprising said magnet and said interface is attached to an item, wherein said item with attached first assembly is placed onto said second assembly with said metal head contacting said magnet through the opening on said interface, thereby securing the item to said second assembly, wherein said metal head rotates about said magnet, allowing the item to be selectively positioned.

2. The attachment and securement system as specified in claim 1 wherein the item is selected from the group consisting of a mobile communication device, a computer device, apparel or apparel accessory.

3. The attachment and securement system as specified in claim 1 wherein the surface or structure to which said assembly is secured is selected from the group consisting of a vertical surface, a horizontal surface, an internal vehicle surface, an external vehicle surface, a furniture surface, a stationary surface or a non-stationary surface.

4. The attachment and securement system as specified in claim 1 wherein the attachment means is comprised of a clamp having a screw actuated opening that is enlarged or reduced in size.

5. An attachment and securement system that allows an item to be secured onto a surface or structure and selectively positioned, wherein said system is comprised of:
a) a first assembly with:
1) a circular magnet having an upper surface, a lower surface, a perimeter edge, a cavity, and an opening that extends through said magnet,
2) an interface having an upper surface, a lower surface, a perimeter edge, and a substantially centered opening,
3) a magnet mating insert having an upper surface, a lower surface, a perimeter edge, and an upward extending tab, wherein said magnet mating insert is dimensioned to fit over the cavity on said magnet such that when said interface is within said cavity, a lip that circumvents an inner perimeter of said magnet is created, wherein said magnet is equally circularly dimensioned to said interface, wherein the lower surface of said magnet contacts and is magnetically adhered to the upper surface of said interface within the cavity on the lower surface of said magnet, such that the lower surface and lip of said magnet along with said interface and said insert create a substantially flush surface, and
b) a second assembly comprising a securing member that is comprised of a screw actuated having an opening, a cavity, and a post that extends outward from the cavity and that terminates at a circular metal head, wherein said second assembly is attached onto a surface or a structure, and said first assembly is attached onto an item, wherein the item is aligned with said second assembly such that the opening on said magnet is directionally in-line with the circular metal head on said securing member, wherein said first assembly magnet contacts said second assembly circular metal head, thereby securing the item to the surface on structure to which said securing member is attached, wherein the circular metal head rotates within the opening about the magnet, allowing the item to be selectively positioned.

6. The attachment and securement system as specified in claim 5 wherein the item is selected from the group consisting of a mobile communication device, a computing device, apparel, or apparel accessory.

7. The attachment and securement system as specified in claim 5 wherein the surface or structure to which said assembly is secured is selected from the group consisting of a vertical surface, a horizontal surface, an internal vehicle surface, an external vehicle surface, a furniture surface, a stationary surface or a non-stationary surface.

8. The attachment and securement system as specified in claim 5 wherein said magnet is selected from the group consisting of neodymium iron boron (NdFeB), samarium cobalt (SmCo), ainico, or ceramic/ferrite.

9. The attachment and securement system as specified in claim 5 that allows an item to be secured onto a surface or structure and selectively positioned, further comprising a protective ring that is located within the cavity on the lower surface of said interface, between the perimeter edge of said magnet and the inner lip, wherein the protective ring provides a non-metallic interface between said first assembly and the item to which said first assembly is attached.

10. The attachment and securement system as specified in claim 9 wherein the protective ring is made of a material selected from the group consisting of rubber, plastic, nylon or a composite material.

11. The attachment and securement system as specified in claim 5 further comprising a flexible extension arm that is attached to said second assembly, wherein the arm allows an item to be secured and positioned at a distance from a surface or structure.

12. An attachment and securement system that allows an object to be secured onto a surface or a structure and selectively positioned, wherein said system is comprised of:
a) a first assembly comprising:
1) a magnet having an upper surface, a lower surface, a perimeter edge, and an opening,
2) a metal interface heaving an upper surface, a lower surface, a perimeter edge and an opening around which extends an upward extending flange, wherein said interface and said magnet are equally dimensioned, wherein the upper surface of said interface contacts and is magnetically adhered to the lower surface of said magnet such that the opening on said interface and the opening on said magnet are aligned and the flange extends upward through the opening on said magnet, and
b) a second assembly comprising a securing member that is comprised of a screw actuated clamp having an opening, a cavity, and a post that extends outward from the cavity and that terminates at a circular metal head, wherein said second assembly is attached onto a surface or a structure, and said first assembly is attached onto an item, wherein the item is aligned with said second assembly such that the openings on said interface and said magnet are directionally in-line with the circular metal head on said securing member, wherein said first assembly contacts said second assembly circular metal head, thereby securing the item to the surface on structure to which said securing member is attached, wherein the circular metal head rotates within the openings about the magnet, allowing the item to be selectively positioned.

13. The attachment and securement system as specified in claim 12 wherein the item is selected from the group consisting of a mobile communication device, a computing device, apparel, or apparel accessory.

14. The attachment and securement system as specified in claim 12 wherein the surface or structure to which said assembly is secured is selected from the group consisting of a vertical surface, a horizontal surface, an internal vehicle surface, an external vehicle surface, a furniture surface, a stationary surface or a non-stationary surface.

15. The attachment and securement system as specified in claim 12 wherein said magnet is selected from the group consisting of neodymium iron boron (NdFeB), samarium cobalt (SmCo), alnico, or ceramic/ferrite.

16. The attachment and securement system as specified in claim 12 wherein said second assembly is further comprised of:
a) a first section having an upper surface, a lower surface, a perimeter edge, and an opening located at the substantial center of said first section, and
b) a second section having an upper surface, a lower surface, a perimeter edge, an opening located at the substantial center of said second section and in alignment with the opening on said first section, and a cavity extending downward into the upper surface, wherein an insert ring is dimensioned to be inserted into the cavity, wherein said second assembly is attached by attachment means onto a surface or structure, with said first section located on an outer surface and said second section located on an inner surface such that said two sections create an interface for said first assembly that is attached onto an item.

17. The attachment and securement system as specified in claim 16 wherein said first section and said second section are any geometric shape.

18. The attachment and securement system as specified in claim 16 wherein said first section and said second section are magnets.

19. The attachment and securement system as specified in claim 16 wherein said second section is a magnet.

20. The attachment and securement system as specified in claim 16 wherein the surface or structure is an apparel accessory.

21. The attachment and securement system as specified in claim 20 wherein the apparel accessory is a backpack strap.

22. The attachment and securement system as specified in claim 16 wherein the attachment means are selected from the group consisting of at least two screws, an adhesive, at least two male and female detents, or a press fit.
